(19) United States
(12) Patent Application Publication
(10) Pub. No.: US 2013/0252070 A1
(43) Pub. Date: Sep. 26, 2013

(54) DUMMY BATTERY CELL FOR SAFE TESTING OF BATTERY SYSTEMS

(71) Applicants: Alexander Reitzle, Neu-Ulm (DE); Ulrich Zimmermann, Hessigheim (DE); Rainer Kern, Stuttgart (DE)

(72) Inventors: Alexander Reitzle, Neu-Ulm (DE); Ulrich Zimmermann, Hessigheim (DE); Rainer Kern, Stuttgart (DE)

(73) Assignee: SB LiMotive Company Ltd., Yongin-si (KR)

(21) Appl. No.: 13/696,820

(22) PCT Filed: Mar. 16, 2011
(86) PCT No.: PCT/EP11/53938

§ 371 Date: Jan. 28, 2013

(30) Foreign Application Priority Data
Nov. 5, 2010 (DE) 102010028862.4

(51) Int. Cl. H01M 10/42

(52) U.S. Cl. CPC H01M 10/4285
USPC 429/156; 429/178

(57) ABSTRACT

A dummy battery cell has a housing, electrodes arranged within the housing, and terminals which are electrically conductively connected to the electrodes. The dummy battery cell is configured such that the housing is configured to hold an electrolyte. Instead of an electrolyte, however, the dummy battery cell has a filler which does not contain an electrolyte. The filler is effective for the battery cell type. A battery, a battery module and a battery system contain at least one such dummy battery cell.

The present invention relates to a dummy battery cell, which has a housing, electrodes arranged within the housing and terminals connected electrically conductively to the electrodes, the dummy battery cell being designed such that the housing can hold an electrolyte, characterized in that, instead of an electrolyte, the dummy battery cell has a filler. Furthermore, the invention relates to a battery, a battery module and a battery system which contains at least one such dummy battery cell.

### PRIOR ART

In the development of battery systems, in particular for the automobile market (currently based for example on a lithium-ion technology), the cells, the battery management system (BMS) and all other control devices must be made to match one another in such a way as to ensure safe working that does not pose any risk to man and/or material. In particular at the beginning of a new venture in BMS development, risks may arise in system tests, since in early stages of development there may still be errors in the software and faults in the hardware, or the software does not yet provide all the necessary functionalities. At present, cells with a low charge state are used for testing the interaction at system level of cells, BMS and all other components, in order to minimize the risks to man and the environment in the event of a “thermal runaway”. However, it is not possible in this way to rule out any possible risk.

If such a “thermal runaway” occurs, elaborate measures are required for firefighting and to avoid contamination of the surroundings. The expression “thermal runaway” means that the thermal reaction in the battery cell gets out of control; excessive and self-energizing heat production in the cell and/or inadequate heat dissipation can cause the cell to open, possibly accompanied by smoke, fire or an explosion. Explanations of the processes occurring in the event of a “thermal runaway” in the case of lithium-ion cells are described, for example, in R. Kern; R. Bindel, R. Uhlenbrock, ATZelektronik 0512009, year 4, pages 22-29.

One possible way of avoiding a “thermal runaway” is to use dummies instead of battery cells, such as for example metal bodies that have the same volume as the original battery cells. However, one disadvantage of these dummies is that they do not have the physical properties of the original battery cells, so there are usually differences in weight, heat capacity, thermal conductivity, mechanical center of gravity, induced vibrational characteristics, etc. These differences may impair the conclusiveness of the tests or matching measures, so that further tests may be necessary or a residual uncertainty may remain.

There is a need for a solution that guarantees maximum safety, while at the same time test and matching results that are as conclusive as possible can be obtained.

### DISCLOSURE OF THE INVENTION

The invention provides a dummy battery cell, which has a housing, electrodes arranged within the housing and terminals connected electrically conductively to the electrodes, the dummy battery cell being designed such that the housing can hold an electrolyte, characterized in that, instead of an electrolyte, the dummy battery cell has a filler. In this case, the filler does not contain an electrolyte that is effective for the battery cell type.

The dummy battery cells according to the invention are distinguished by the fact that they are configured or can be configured substantially identically to the original battery cells to be tested, of the corresponding battery cell type, the only difference being that, instead of the electrolyte, they contain a filler which does not act as an electrolyte that is effective for the corresponding battery cell system. In the case of the invention, the electrochemical function of the battery cell is disabled. The dummy battery cells according to the invention therefore cannot store and give off again any electrical energy, and consequently also cannot be forced into a “thermal runaway”.

The present invention therefore provides dummy battery cells which have the same properties as the original battery cells that may possibly have to be used later in an intended application, in particular with respect to the thermal behavior, the mechanically induced behavior, the behavior under corrosive conditions, etc. However, the dummy battery cells according to the invention cannot store electrical energy and consequently they also cannot take a charge. This makes it possible, particularly at the beginning of development activities on components that monitor and control the electrical behavior of the cells, to follow a safe and inexpensive procedure, since the dummy battery cells cannot be forced into a “thermal runaway”, and can possibly be used again.

Use of the dummy battery cells according to the invention allows batteries, battery modules or entire battery systems to be constructed and the interaction and functional behavior of the individual components to be tested under typical automotive conditions, such as for example vibration, changes in temperature, changes in humidity, road gritting, etc., without involving the risk of gas escaping, fire or an explosion while the test is being conducted.

In principle, the structure of a dummy battery cell according to the invention may be based on a cell of each battery cell type or each battery cell technology. A precondition is that the dummy battery cell has electrodes, preferably at least one anode and at least one cathode. The electrodes are arranged in a housing. The housing may be configured in such a way that it closes off the electrodes from the outside world and provides a space in which an electrolyte can be held. The electrodes are connected electrically conductively to terminals. The terminals or poles may be formed and arranged in such a way that the dummy battery cell can be connected via these terminals in an electrically conducting manner to a voltage source and/or a power supply system. The dummy battery cell according to the invention is formed in such a way that the housing can hold an electrolyte. The dummy battery cell is preferably formed such that, once it holds an electrolyte, the electrodes are at least partially in direct contact with the electrolyte.

The structure of the dummy battery cell according to the invention preferably follows the typical structure of a battery cell of the type of the original battery cell to be tested and is known to a person skilled in the art. Ideally, the structure is identical to the structure of the original battery cell to be tested, with the proviso that the dummy battery cell according to the invention does not have an electrolyte that is suitable for this battery cell type. Suitable battery cell types comprise electrochemical energy storage devices, in particular battery cells or rechargeable battery cells of all common rechargeable battery technologies. In particular, the following battery cell types are suitable: battery or rechargeable battery cells of the type Pb—lead battery, NiCd—nickel-cadmium battery, NiH2—nickel-hydrogen battery, NiMH—nickel-metal-hydride battery, Li-ion—lithium-ion battery, LiPo—lithium-polymer battery, LiFe lithium-metal battery, LiMn lithium-manganese battery, LiFePO₄—lithium-iron-phosphate battery, LiTi—lithium-titanate battery, RAM—Rechargeable Alkaline Manganese, NiFe—nickel-iron battery, Na/NiCl—sodium-nickel-chloride high-temperature battery, SCiB—Super Charge Ion Battery, silver-zinc battery, silicone battery, vanadium-redox battery and/or zinc-bromine battery. With particular preference, the structure of the dummy battery cells according to the invention is based on battery cells of the lithium-ion battery cell type.

An electrolyte is understood as meaning a composition which, when a voltage is applied, conducts electric current under the influence of the electrical field thereby produced, its electrical conductivity and the charge transfer being brought about by the directed movement of ions. In this case, the composition of the electrolyte is made to match the respective battery cell type in such a way that the electrolyte allows a directed migration of ions between the electrodes and consequently ensures a charging and/or discharging process of the battery cell. The electrolyte may be, for example, a solid or liquid composition. Usually, electrolytes contain conducting agents, such as for example acids, bases or salts (conductive salts), which may take the form of ions when a voltage is applied. In addition, electrolytes may comprise one or more other compounds or substances, such as for example solvents or stabilizers. Suitable electrolytes for the battery cell types mentioned are known to a person skilled in the art. An electrolyte that is suitable for a specific battery cell type is understood as meaning an electrolyte that is capable of initiating a charging and/or discharging process for the battery cell type chosen.

In the case of a dummy battery cell for a battery cell of the lithium-ion cell type, the anode contains or consists of graphite and the cathode contains or consists of a lithium transition metal oxide, preferably LiCoO₂, LiNiO₂, an LiMn oxide, or an Al-based or Al-stabilized oxide or mixtures or blends containing one or more of the compounds mentioned. Typically used in lithium-ion cells is an electrolyte that contains organic carbonates, such as for example dimethyl carbonate, diethyl carbonate, ethylene carbonate and/or propylene carbonate, or mixtures thereof as a solvent, and conductive salts dissolved therein, such as for example LiPF₆ or LiBF₄.

The dummy battery cell according to the invention is characterized in that, instead of an electrolyte, the dummy battery cell has a filler, which does not contain an electrolyte that is effective for the battery cell type. The fact that the dummy battery cell does not contain an electrolyte that is effective for the chosen battery cell type means that, when an electrical voltage is applied to the terminals of the dummy battery cell, there is substantially no directed ion movement between the electrodes that allows a charging and/or discharging process, or does not allow such a process to any appreciable extent. The filler of the dummy battery cell may be chosen and constituted in such a way that, when a charging voltage is applied to the terminals, insufficient ions are provided to ensure a charging process in the dummy battery cell.

The filler may, for example, be in a solid form or in a liquid form; the filler is preferably in the same state of aggregation in which the electrolyte typically is in the corresponding original battery cell. This ensures that the dummy battery cell according to the invention behaves as similarly as possible to the corresponding original battery cell.

In a preferred embodiment, the dummy battery cell according to the invention may contain a filler which corresponds substantially to the composition of the electrolyte that is usually used for the chosen battery cell type. A precondition for this is that the filler then does not contain the corresponding ion carrier, the corresponding acid, base or corresponding conducting agent, for example conductive salt, or contains them in a concentration that substantially does not allow a charging process in the dummy battery cell, or ensures that such a process does not occur to any appreciable extent. The advantage of this embodiment is that the filler has the greatest possible similarity to the electrolyte present in the original battery cell, and thus achieves the overall effect that the dummy battery cell has the greatest possible similarity to the corresponding original battery cell. The greater the similarity between the dummy battery cell and the corresponding original battery cell, the more conclusive the measurement results that can be achieved with the dummy battery cell according to the invention.

The dummy battery cell may preferably contain a filler which contains or consists of one or more solvents that are present in the electrolyte usually used for the battery cell type.

In particular whenever a cell of the lithium-ion cell type is concerned, the filler of the dummy battery cell according to the invention may preferably contain or consist of one or more organic carbonates or mixtures thereof. These organic carbonates may be, in particular, dimethylene carbonate, diethylene carbonate, ethylene carbonate, propylene carbonate or mixtures thereof.

In a further preferred embodiment, the filler of the dummy battery cell according to the invention may contain or consist of silicones, silicone-containing compounds or substituted or unsubstituted polysiloxane-containing polymers. It can be ensured in this way that, in the case of filler being let out of the dummy battery cell, for example due to misuse or damage, the gases escaping can only be ignited with difficulty.

In a preferred embodiment, the dummy battery cell according to the invention has the filler in a quantity such that the weight of the filler deviates by no more than 10% by weight from the total weight of the electrolyte usually used in the chosen original battery cell type, preferably by no more than 5% by weight, particularly preferably by no more than 2% by weight, most particularly preferably by no more than 1% by weight. This achieves the effect that the substitution of the electrolyte by the filler does not lead to any appreciable or relevant difference in weight between the dummy battery cell and the corresponding original battery cell. The dummy battery cell according to the invention then also behaves like the corresponding original battery cell with respect to the total weight.

The present invention also relates to a battery, a battery module and/or a battery system, characterized in that one or more or all of the cells of the battery, of the battery module or of the battery system are dummy battery cells according to the invention. A battery is understood in this case as meaning an electrochemical energy storage device that has at least one battery cell or dummy battery cell. In the case of a battery module, a number of battery cells or dummy battery cells are combined to form a unit, possibly a functional unit, a battery system being understood as meaning more highly organized arrangements that have a number of battery cells or dummy battery cells.

The dummy battery cell according to the invention or batteries, battery modules and/or battery systems containing such dummy battery cells may be used in particular for testing the behavior of the dummy battery cell or of the corresponding original battery cell under environmental influences or for matching various further system components, such as for example battery management systems, to a dummy battery cell or the corresponding original battery cell.

### DRAWINGS

Exemplary embodiments of the invention are explained in more detail on the basis of the description that follows and the drawings, in which:

FIG. 1 shows a schematic representation of an original battery cell of the lithium-ion cell type;

FIG. 2 shows a schematic representation of a dummy battery cell according to the invention consisting of an original battery cell of the lithium-ion cell type.

### EMBODIMENTS OF THE INVENTION

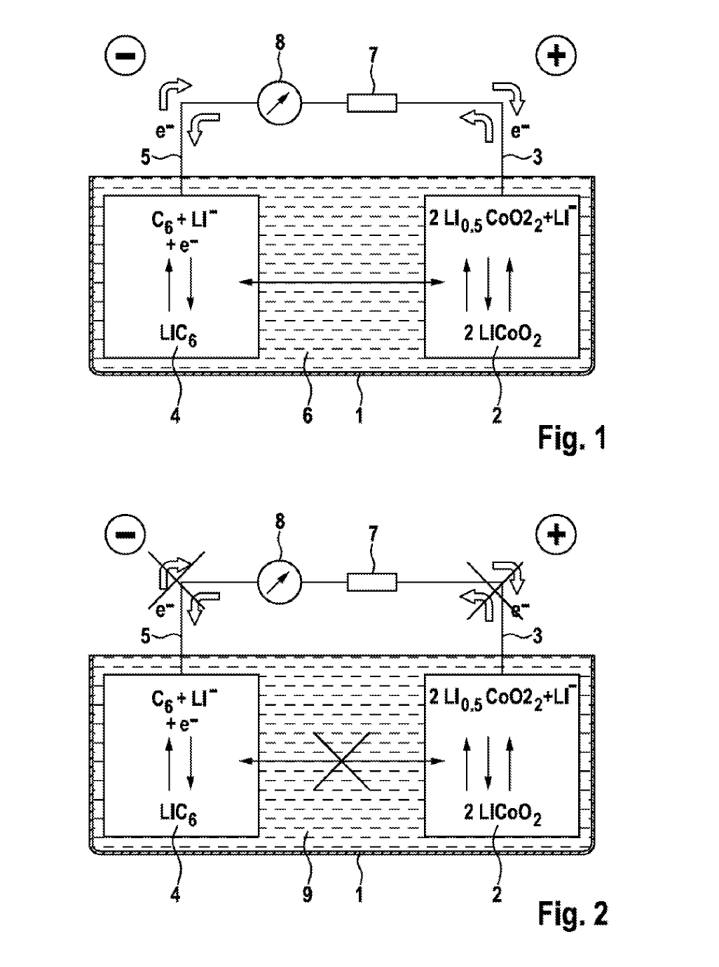

In FIG. 1, an original battery cell of the lithium-ion cell type is shown. The original battery cell has a cathode 2 and an anode 4, which are arranged in a housing 1. The cathode 2 is connected in an electrically conducting manner to the cathode terminal 3, while the anode 4 is connected in an electrically conducting manner to the anode terminal 5. Both the cathode 2 and the anode 4 are in direct contact with an electrolyte 6, which is likewise arranged in the housing. The cathode terminal 3 and the anode terminal 5 are connected via lines with a line resistor 7 to a voltage source 8, which provides a suitable charging voltage, for example of 3.6 V.

In the case of the currently used lithium-ion cell, the material of the anode 4 consists substantially of graphite and the cathode 2 contains LiCoO₂ or blends with lithium manganese oxide, lithium nickel oxide or Al-based-stabilized oxides. The electrolyte 6 may, for example, contain mixtures of organic carbonates as a solvent, for example diethylene carbonate, dimethylene carbonate, ethylene carbonate, and/or propylene carbonate, while LiPF₆ or LiBF₄ is used for example as the conducting salt.

During the charging, lithium ions are intercalated into the graphite of the anode 4. These lithium ions originate from the material of the cathode 2 and must migrate from the cathode 2 through the electrolyte 6 to the anode 4. This migration takes place as pairs of ions (for example LiPF₆) comprising a lithium cation and a counteranion of the electrolyte. When they arrive at the anode 4, they are intercalated into the anode material. This is represented in FIG. 1.

In FIG. 2, an embodiment of a dummy battery cell according to the invention is represented. In this case, the dummy battery cell represented is configured as a dummy of the original battery cell from FIG. 1. In order that as many physical properties as possible of a dummy battery cell according to the invention coincide with the properties of the corresponding original battery cell, the same active materials are used for the electrodes, for example graphite for the anode 4 and lithium transition metal oxides for the cathode 2. Instead of the electrolyte 6, the dummy battery cell from FIG. 2 has a filler 9, which substantially coincides in its composition to the electrolyte 6 of the original battery cell from FIG. 1, though the filler 9 does not contain any conductive salt that is effective for the original battery cell type.

In order to prevent the risk of an electrochemical charging and/or discharging reaction in the dummy battery cell, graphite is used for the anode 4 and LiCoO₂ or blends with LiNiO₂ and Li-Mn oxides are used for the cathode 2. When these compounds are used, the cell is considered to be completely discharged, since no lithium has been removed from the cathode material and no lithium is intercalated in the graphite.

In order to completely prevent a possible charging and/or discharging reaction, for example due to an external voltage being applied by chance, the filler 9, which may comprise a mixture of organic carbonates, is used in the dummy battery cell instead of the electrolyte 6. No conducting agent or conductive salt that is effective for the original battery cell type is used in the filler 9. Although this results in a calculable error in the mass of the dummy battery cell as compared with the corresponding original battery cell of max. 1% by weight (in the case of a used conductive salt LiPF₆ and a typical concentration of 1 mol/l, corresponding to 152 g/l and a maximum cell weight of about 1000 g), which is also reflected in the error of the resonant frequency (m˜1/√v, or, resolved on the basis of the frequency error, max. 5%), this error is usually subsumed in the measuring accuracy that is prescribed in the public standards of the automobile industry for the measuring instruments.

This approach avoids the electrochemical charging reaction in the dummy battery cell. The possible application of a charging voltage to such a dummy battery cell does not bring about any migration of lithium ions from the cathode material of the cathode 2 to the graphite of the anode 4, since there is no corresponding counteranion to the lithium cation in the filler 9. This prevents lithium migration through the filler 9, see FIG. 2. Otherwise, the dummy battery cells behave physically like the corresponding original battery cells. The only difference is that no “thermal runaway” can take place in the dummy battery cell.

1. A dummy battery cell, comprising:
a housing;
electrodes arranged within the housing; and
terminals connected electrically conductively to the electrodes, wherein:
the dummy battery cell is configured such that the housing is configured to hold an electrolyte; and
instead of the electrolyte, the dummy battery cell has a filler which does not contain the electrolyte, the filler being effective for a battery cell type corresponding to the dummy battery cell.

2. The dummy battery cell as claimed in claim 1, wherein when a charging voltage is applied to the terminals, the filler provides insufficient ions to ensure a charging process in the dummy battery cell.

3. The dummy battery cell as claimed in claim 1, wherein the dummy battery cell is a lithium-ion cell type.

4. The dummy battery cell as claimed in claim 1, wherein a weight of the filler deviates by no more than 10% by weight from a total weight of the electrolyte usually used for the battery cell type.

5. The dummy battery cell as claimed in claim 1, wherein:
the filler corresponds substantially to a composition of the electrolyte that is usually used for the battery cell type; and
the filler does not contain a corresponding conductive agent, or contains the corresponding conductive agent in a concentration that substantially does not allow a charging process in the dummy battery cell.

6. The dummy battery cell as claimed in claim 1, wherein the filler contains or consists of a solvent that is present in the electrolyte usually used for the battery cell type.

7. The dummy battery cell as claimed in claim 1, wherein the filler contains or consists of one or more organic carbonates or mixtures thereof.

8. The dummy battery cell as claimed in claim 1, wherein the filler contains or consists of dimethylene carbonate, diethylene carbonate, ethylene carbonate, propylene carbonate or mixtures thereof.

9. The dummy battery cell as claimed in claim 1, wherein the filler contains or consists of silicone, silicone-containing compounds or polysiloxane-containing polymers.

10. A battery comprising:
a plurality of cells, wherein at least one of the plurality of cells is a dummy battery cell comprising:
a housing;
electrodes arranged within the housing; and
terminals connected electrically conductively to the electrodes, wherein:
the dummy battery cell is configured such that the housing is configured to hold an electrolyte; and
instead of the electrolyte, the dummy battery cell has a filler which does not contain the electrolyte, the filler being effective for a battery cell type corresponding to the dummy battery cell.

11. A battery module comprising:
at least one battery having a plurality of cells, wherein at least one of the plurality of cells is a dummy battery cell comprising:
a housing;
electrodes arranged within the housing; and
terminals connected electrically conductively to the electrodes, wherein:
the dummy battery cell is configured such that the housing is configured to hold an electrolyte; and
instead of the electrolyte, the dummy battery cell has a filler which does not contain the electrolyte, the filler being effective for a battery cell type corresponding to the dummy battery cell.
